(19) United States
(12) Patent Application Publication
(10) Pub. No.: US 2010/0178862 A1
(43) Pub. Date: Jul. 15, 2010

(54) Stack Effect Mitigation

(75) Inventors: Michael K. Sahm, Avon, CT (US); Nathan S. Hariharan, Vernon, CT (US); Bryan R. Siewert, Westbrook, CT (US)

Correspondence Address: BACHMAN & LAPOINTE, P.C. (UTC), 900 CHAPEL STREET, SUITE 1201, NEW HAVEN, CT, 06510-2802, US

(73) Assignee: CARRIER CORPORATION, Farmington, CT (US)

(21) Appl. No.: 12/529,093

(22) PCT Filed: Mar. 22, 2007
(86) PCT No.: PCT/US07/64694

§ 371 Date: Mar. 8, 2010

(51) Int. Cl. F24F 7/00; B66B 1/34; F24F 11/00; E04F 17/04

(52) U.S. Cl. 454/254; 52/30; 52/1; 52/302.1

(57) ABSTRACT

A building (20) has an atrium (24) and an elevator hoistway (40). To mitigate a stack effect in the atrium, a fan (62) may provide a downward airflow (60) through the hoistway.

### U.S. GOVERNMENT RIGHTS

The invention was made with U.S. Government support under contract 70NANB4H3024 awarded by the National Institute of Standards and Technology. The U.S. Government has certain rights in the invention.

### BACKGROUND OF THE INVENTION

The disclosure relates to building climate control. More particularly, the disclosure relates to mitigation of stack effect in building atriums.

The tall atrium has become a common architectural element of hotel and office buildings. In an exemplary configuration, the atrium extends substantially the entirety of the building height and may be fully or partially surrounded by occupied floor space. Often, elevator stacks are located in or adjacent to the atrium.

The height of the atrium may contribute to a stack effect airflow. Air in the atrium may be heated. Exemplary heating comes from exposure to the occupied areas adjacent (e.g., surrounding) the atrium. Alternative heating may be solar heating. Solar heating is particularly relevant in atriums that are exposed to sunlight along at least one side. The heated air rises. As the air rises, it may gather further heat. One effect is to transfer heat upward. Another effect is that the airflow causes a heightwise-varying pressure difference between the atrium and the outdoor environment. This may encourage air leakage.

### SUMMARY OF THE INVENTION

One aspect of the disclosure involves a building having an atrium and an elevator hoistway. Means are provided at least partially in the hoistway for mitigating a stack effect in the atrium.

In various implementations, the means may include a fan within the hoistway. The fan may be within a duct. The fan and duct may be added in a retrofit.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a first schematic vertical sectional view of a building.

FIG. 2 is a schematic horizontal sectional view of the building of FIG. 1.

FIG. 3 is a second schematic vertical sectional view of the building of FIG. 1.

FIG. 4 is a graph of pressure difference against height for the building of FIG. 1.

FIG. 5 is a graph of atrium temperature against height for the building of FIG. 1.

Like reference numbers and designations in the various drawings indicate like elements.

### DETAILED DESCRIPTION

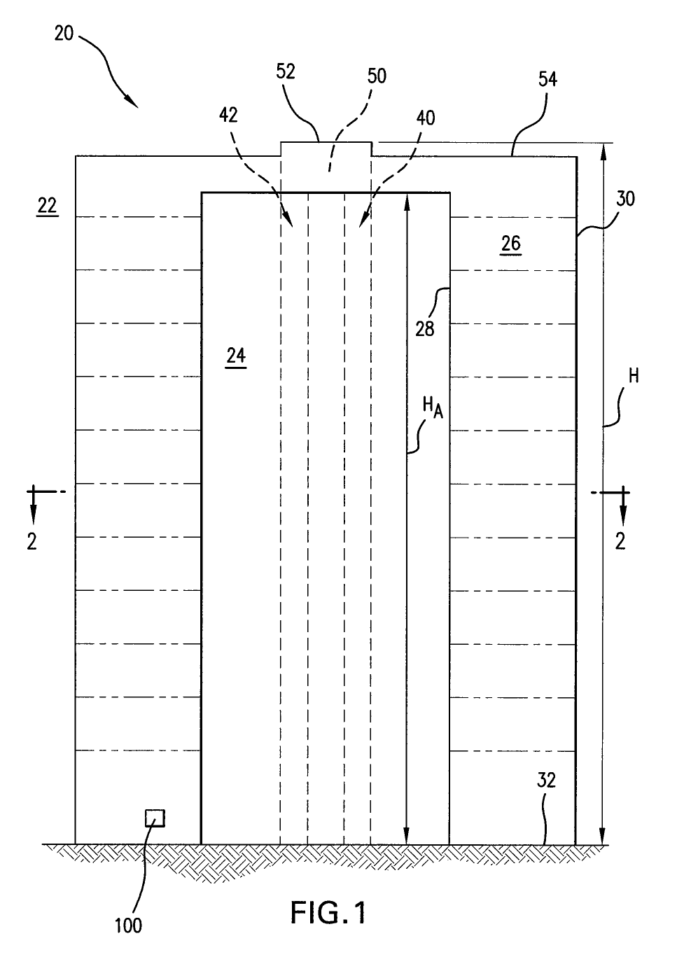

FIGS. 1-3 show an exemplary building 20 within an external (outdoor) environment 22. The building has an atrium 24. Occupied floor space 26 may fully or partially surround the atrium and extend from an interior wall 28 at the atrium to a building exterior wall 30. Along the atrium, one or more of the building exterior wall may be windowed to admit light to the atrium and heat the insolated portion of the atrium.

The occupied space may contain a large number of individual floors, one above another. An exemplary number of floors is at least ten, more particularly at least twenty. An exemplary building height H above a ground surface 32 is at least fifty meters, more particularly, at least 120 meters. An exemplary atrium height H_{A} is at least 75% of H.

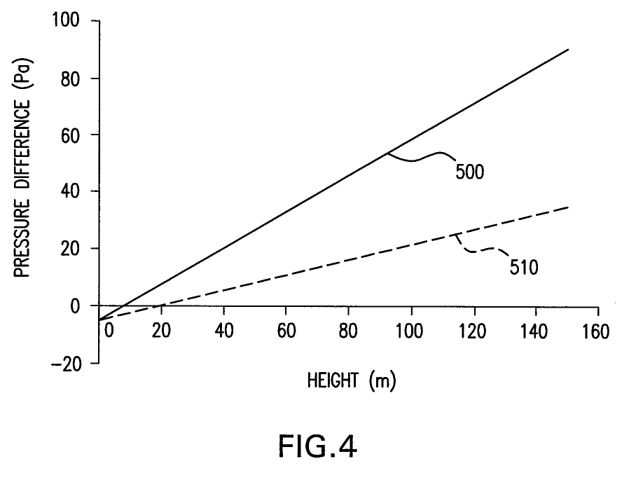

The atrium may be subject to a stack effect causing associated heightwise-varying differences in pressure and temperature between the atrium 20 and the external environment 22. FIG. 4 shows a graph 500 of pressure difference of the atrium relative to the external environment for a baseline building configuration. Near the ground, the atrium pressure is slightly less than the external pressure. With increasing height, the atrium pressure is increasingly greater than the external pressure.

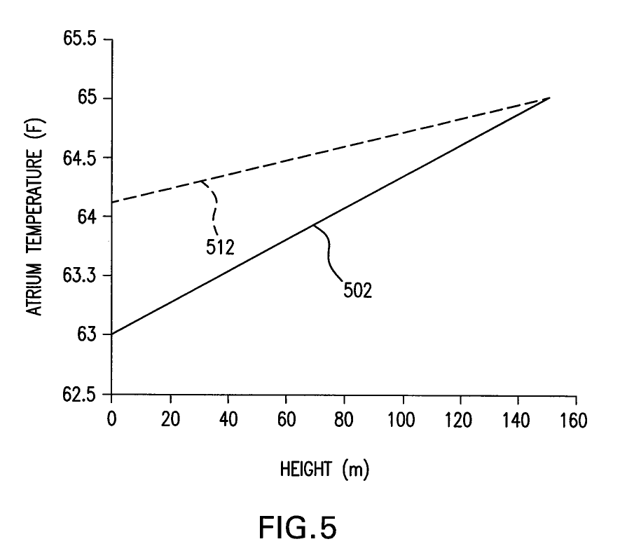

FIG. 5 similarly shows an exemplary graph of atrium temperature 502 against height. Conditions simulate winter in a temperate climate or fall/spring in a colder climate. Exemplary outside air temperature is ˜38° F., and internal heated temperature ˜68° F. The simulation was initialized with both internal/external temperature at 38° F., and the internal space was heated till the average temperature reached ˜68° F. Due to the stack effect, the atrium temperature increases with height.

To mitigate the stack effect, solutions may be implemented in association with an elevator system. More particularly, in a retrofit situation, solutions may be implemented via modification of an existing elevator system.

To transport people and cargo among the various floors, the building may include one or more elevators. An exemplary construction places multiple elevators in a common hoistway. FIGS. 1-3 show a pair of elevator hoistways 40 and 42. Each exemplary hoistway has a plurality of shafts 44A, 44B, and 44C and 44D, 44E, and 44F, respectively. As is discussed in further detail below, each of the shafts may contain or have previously contained one or more associated elevator cars 46. The shafts or other portions of the hoistway may also contain or have contained associated counterweights (not shown). Elevator equipment 50 may be located in an equipment room 52 at the top 54 of the building. The exemplary elevators and counterweights may be suspended by cables (not shown) and raised and lowered by electric motors (not shown).

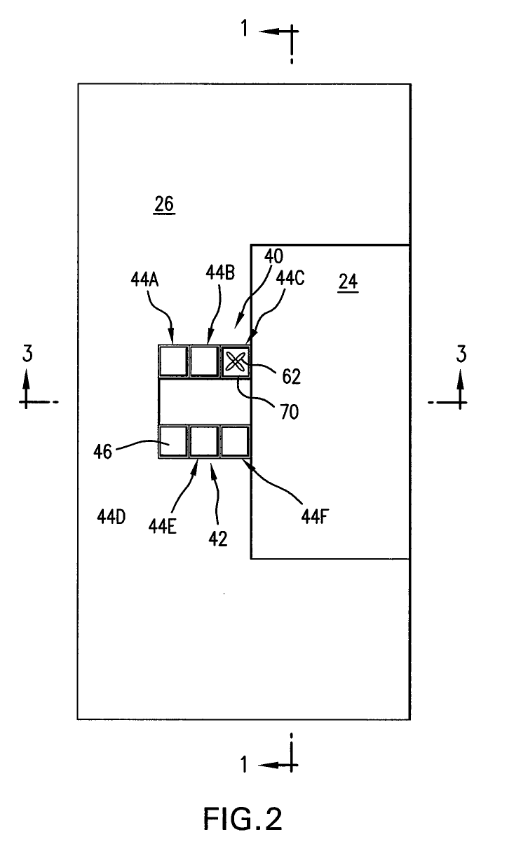

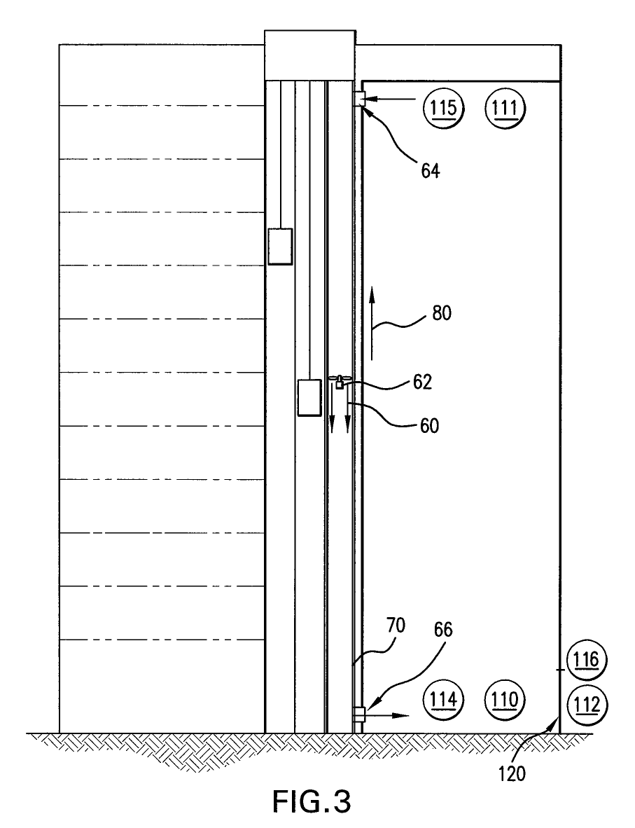

Means for mitigating the stack effect may be provided at least partially within at least one of the hoistways. Exemplary means may drive an airflow 60 (FIG. 3) downward through the hoistway. The means may include a fan 62 to drive the airflow. The airflow may be taken from the atrium and returned to the atrium. The airflow may be taken through an inlet vent 64 and returned through an outlet/return vent 66. The airflow may be carried through a conduit/duct 70 (FIG. 2) within the hoistway.

The airflow 60 provides a return of the stack effect airflow 80. The exact nature and dynamics of the stack effect airflow 80 will depend on a number of considerations including atrium exposure to sunlight (insolation) and atrium geometry. Nevertheless, the flow 60 may mitigate effects of the stack effect along all or a portion of the atrium height.

FIG. 4 shows an exemplary pressure difference 510 reflecting the mitigation. The heightwise increase in pressure difference is reduced relative to the pressure difference 500. The particular simulation held the ground level pressure difference constant. In practice, however, the system may operate to change that pressure difference (e.g., reduce its magnitude so as to reduce ground level air infiltration). Similarly, FIG. 5 shows an atrium temperature 512 which is relatively more constant over the atrium height than is the temperature 502.

The means may include a controller 100 (FIG. 1) operating the fan and, optionally, controlling opening and closing of the vents 64 and 66 via associated actuators (not shown). The controller may be integrated within the main controller of the building's heating ventilation and air conditioning (HVAC) system. The controller may operate the fan and vents responsive to sensed and/or programmed inputs. Exemplary sensed inputs include temperatures and pressures at various locations within and external to the building. Exemplary programmed inputs include time of day and seasonal factors. FIG. 3 shows exemplary temperature sensors 110, 111, and 112 and pressure sensors 114, 115, and 116 respectively: interior the base of the atrium; interior near the top of the atrium; and exterior near the main doors. Other sensors may also be present. For ease of reference, t_1, t_2, and t_3 are the temperatures sensed by the respective temperature sensors 110, 111, and 112 and p_1, p_2, and p_3 are the pressures sensed by the respective pressure sensors 114, 115, and 116.

One exemplary protocol is for normal operations in winter to relieve stack effect. In an exemplary implementation, if (t_1-t_3)> a threshold temperature (e.g., 25° F.), then a pressure-dependent fan operation may be engaged. An example of the pressure dependency is based upon the pressure difference (p_2-p_1). The example uses two non-zero fan speeds (e.g., a low speed and a high speed). If (p_2-p_1)> a first threshold pressure (e.g., 60 Pa) then the fan is operated at high speed. If not, but sill greater than a lower second threshold pressure (e.g., 30 PA), then the fan is operated at the low speed. The number and values of particular fan speeds and the associated thresholds may be optimized for the particular building.

Another exemplary protocol is for normal operations in winter to reduce cold air infiltration. In an exemplary implementation, if (t_1-t_3)> a threshold temperature (e.g., 25° F.), then a pressure-dependent fan operation may be engaged. If (p_3-p_1)> a first threshold pressure (e.g., 40 Pa) then the fan is operated at high speed. If not, but sill greater than a lower second threshold pressure (e.g., 20 PA), then the fan is operated at the low speed. The number and values of particular fan speeds and the associated thresholds may be optimized for the particular building.

Another exemplary protocol is for normal operations in winter to provide enhanced mixing and improve comfort within the building. In an exemplary implementation, if (t_1-t_3)> a threshold temperature (e.g., 25° F.), then a temperature-dependent fan operation may be engaged. If (t_2-t_1)> a first threshold temperature (e.g., 8° F.) then the fan is operated at high speed. If not, but sill greater than a lower second threshold temperature (e.g., 5° F.), then the fan is operated at the low speed. The number and values of particular fan speeds and the associated thresholds may be optimized for the particular building.

Another exemplary protocol is for normal operations in summer to provide enhanced mixing and improve comfort within the building. In an exemplary implementation, if (t_3-t_1) >a threshold temperature (e.g., 20° F.), then a temperature-dependent fan operation may be engaged. If (t_2-t_1)> a first threshold temperature (e.g., 12° F.) then the fan is operated at high speed. If not, but sill greater than a lower second threshold temperature (e.g., 8° F.), then the fan is operated at the low speed. The number and values of particular fan speeds and the associated thresholds may be optimized for the particular building. Fan speed may be subject to continuous control rather than limited to a small number of discrete speeds. The control function may be a smooth continuous function based upon the sensed parameters, their differences, and the like.

The control system may be programmed via software or hardware to operate in one or more of these modes either separately or simultaneously. Simultaneous operation (e.g. for the various winter modes) could be additive/cumulative (e.g., a higher speed adopted where more than one of the modes indicates a need for high speed operation) or alternative (e.g., a given high speed is maintained if any of the modes indicates a need for high speed). the modes may be combined with abnormal (e.g., emergency) modes. Examples of emergency modes are building fire modes to achieve desired effects in smoke control or fire control. the emergency modes may also be responsive to sensed conditions (e.g. smoke or fire detectors) or manual input.

The exemplary mitigation means is illustrated as a retrofit of an existing building wherein the elevator car from the shaft 44C (FIG. 2) has been removed. The exemplary duct 70 is installed as a liner in the shaft 44C. The fan is installed within the duct. The controller (not shown) for the remaining elevators may be reprogrammed to compensate for the loss of the car from the shaft 44C. One or more of the temperature sensors and/or the pressure sensors may be from the existing HVAC system, although one or more such sensors may be added.

In alternative implementations, an elevator car need not be taken out of service. For example, the hoistway may have sufficient surplus space to accommodate an added duct. In an original architectural design, the hoistway may be designed with sufficient space for the duct.

One or more embodiments of the present invention have been described. Nevertheless, it will be understood that various modifications may be made without departing from the spirit and scope of the invention. For example, details of local climate (including seasonal fluctuations), building way out and building orientation may influence any particular implementation. Additionally, an existing building, or constraints on revising an existing architectural plan may influence the particular implementation. Accordingly, other embodiments are within the scope of the following claims.

What is claimed is:

1. A building (20) comprising:
an atrium (24);
an elevator hoistway (40); and
means, at least partially in the hoistway, for mitigating stack effect airflow in the atrium.

2. The building of claim 1 wherein:
the means comprises an inlet (64) in an upper 10% of the atrium and an outlet (66) in a lower 10% of the atrium.

3. The building of claim 1 wherein:
the means comprises a fan (62) in the hoistway.

4. The building of claim 3 wherein:
the fan is located within 20% of the middle of the hoistway.

5. The building of claim 1 wherein:
the atrium has a eight of at least 50 m.

6. The building of claim 1 wherein the means comprises:
at least one interior pressure sensor (114,115);
at least one exterior pressure sensor (116); and
a controller (100) coupled to the at least one external pressure sensor and the at least one internal pressure sensor and configured to operate responsive to a pressure difference.

7. The building of claim 1 wherein the means comprises:
at least one low elevation interior pressure sensor (114);
at least one high elevation interior pressure sensor (115); and
a controller (100) coupled to the at least one external pressure sensor and the at least one internal pressure sensor and configured to operate responsive to a pressure difference.

8. The building of claim 1 wherein the means comprises:
at least one interior temperature sensor (110,111);
at least one exterior temperature sensor (112); and
a controller (100) coupled to the at least one external pressure sensor and the at least one internal pressure sensor and configured to operate responsive to a temperature difference.

9. A building (20) comprising:
an atrium (24);
an elevator hoistway (40); and
a fan (62) positioned to drive an airflow (60) vertically within the hoistway (40), from an inlet (64) to an outlet (66), the outlet below the inlet, the airflow passing from the outlet to the atrium and returning to the inlet.

10. The building of claim 9 further comprising:
a controller (100) coupled to at least one pressure sensor and at least one temperature sensor and configured to operate the fan responsive to sensed pressure and temperature.

11. A method for mitigating stack effect airflow in a building, the method comprising:
forcing a return airflow downward through an elevator hoistway, the return airflow acting to reduce a relative pressure differential between the atrium and a building exterior near the top of the atrium.

12. The method of claim 11 wherein the return inflow is drawn in through an inlet at the atrium and returned through an outlet at the atrium.

13. The method of claim 12 wherein the inlet is within a top 10% of a height of the atrium and the outlet is within a bottom 10% of a height of the atrium.

14. The method of claim 11 wherein the return airflow is forced downward through a duct within the hoistway.

15. The method of claim 11 wherein the forcing is responsive to a combination of all of:
a sensed difference between interior and exterior temperatures;
a sensed difference between interior and exterior pressures;
a sensed height-wise interior temperature difference; and
a sensed height-wise interior pressure difference.

16. The method of claim 11 wherein the forcing is responsive to at least one of:
a sensed difference between interior and exterior temperatures;
a sensed difference between interior and exterior pressures;
a sensed height-wise interior temperature difference; and
a sensed height-wise interior pressure difference.

17. The method of claim 11 wherein the forcing is responsive to at least two of:
a sensed difference between interior and exterior temperatures;
a sensed difference between interior and exterior pressures;
a sensed height-wise interior temperature difference; and
a sensed height-wise interior pressure difference.

18. The method of claim 11 implemented in the retrofitting of an existing building, the retrofitting adding a duct within the hoistway to accommodate the forced airflow.

19. The method of claim 11 implemented in the retrofitting of an existing building, the retrofitting removing an elevator car from the hoistway to accommodate the forced airflow.

20. The method of claim 19 wherein the retrofitting adds a divider to the hoistway to accommodate the forced airflow.
